(19) United States
(12) Patent Application Publication
(10) Pub. No.: US 2020/0398367 A1
(43) Pub. Date: Dec. 24, 2020

(54) WELD RIVET AND METHOD FOR JOINING WORKPIECES OF DISSIMILAR MATERIALS

(71) Applicant: GM Global Technology Operations LLC, Detroit, MI (US)

(72) Inventors: Pei-chung Wang, Troy, MI (US); Bradley J. Blaski, Sterling Heights, MI (US); Steven Cipriano, Chesterfield Township, MI (US); Scott Hooker, Sterling Heights, MI (US)

(21) Appl. No.: 16/450,328

(22) Filed: Jun. 24, 2019

(51) Int. Cl. B23K 11/00

(52) U.S. Cl. CPC B23K 11/0066

(57) ABSTRACT

A weld rivet for use in a method of resistance element welding of dissimilar materials includes a shank portion, a cap portion, and a coating. The shank portion has a cylindrical shape, a first end, and a second end opposite the first end. The cap portion has a flat disc shape, a top surface, and a bottom surface. The bottom surface of the cap portion is disposed on the first end of the shank portion. The coating is disposed on the bottom surface of the cap portion. The coating electrically insulates the cap portion.

### INTRODUCTION

The present disclosure relates generally to a method of joining workpieces and more particularly to a weld rivet and a method of joining two workpieces of dissimilar materials.

Using current technology of resistance element welding allows vehicle manufacturers, as well as other manufactures, to join steel parts together in a highly robust and efficient process. In many high-rate production facilities assembling and joining parts together is automated. However, in recently new materials have been proposed for use as body panels and support structure making the joining of such dissimilar materials more challenging while using the same highly automated and capital intensive manufacturing processes as in the past. However, when joining dissimilar materials using the same methods as used previously has proven difficult and not nearly as capable or as efficient. Thus, a new method and technology is required to provide the same performance from the previous resistance element welding process while having the capability of joining together dissimilar materials.

Accordingly, there is a need in the art for a new manufacturing method using a new welding implement that is capable of joining two or more workpieces of different materials.

### SUMMARY

A weld rivet for use in resistance element welding of dissimilar materials is provided. The weld rivet includes a shank portion, a cap portion, and a coating. The shank portion has a cylindrical shape, a first end, and a second end opposite the first end. The cap portion has a flat disc shape, a top surface, and a bottom surface. The bottom surface of the cap portion is disposed on the first end of the shank portion. The coating is disposed on the bottom surface of the cap portion. The coating electrically insulates the cap portion.

In one example of the present disclosure, the coating is further disposed on an outer surface of the shank portion.

In another example of the present disclosure, the top surface of the cap portion has a rounded shape.

In yet another example of the present disclosure, the cap has a diameter in the range between about 8 mm and 16 mm and the shank has a diameter in the range between about 4 mm and 8 mm.

In yet another example of the present disclosure, the second end of the shank portion has a piercing tip capable of piercing through an aluminum workpiece.

In yet another example of the present disclosure, the second end of the shank portion has a self-drilling tip capable of forming a hole through a nonmetallic sheet.

Another example of a weld rivet for use in resistance element welding of dissimilar materials is provided. The weld rivet comprises a shank, a cap portion, and a coating. The shank portion has a cylindrical shape, a first end, and a second end opposite the first end. The second end of the shank portion has a forming tip capable of forming a hole through a workpiece. The cap portion has a flat disc shape, a rounded top surface, and a bottom surface. The bottom surface of the cap portion is disposed on the first end of the shank portion. The coating is disposed on the bottom surface of the cap portion and the outer surface of the shank portion. The coating electrically insulates the cap portion and the shank portion.

In one example of the present disclosure, the cap portion has a diameter of about 8 mm and the shank portion has a diameter of about 4 mm.

In another example of the present disclosure, the second end of the shank portion has a piercing tip capable of piercing through an aluminum workpiece.

In yet another example of the present disclosure, the second end of the shank portion has a self-drilling tip capable of forming a hole through a nonmetallic sheet.

A method of joining dissimilar materials is provided. The method comprises providing a first workpiece, a second workpiece, and a weld rivet. The weld rivet is inserted through a hole of the first workpiece. The second workpiece is disposed adjacent to the first workpiece such that the weld rivet is in contact with the second workpiece. A high current electrical charge is applied between the weld rivet and the second workpiece.

In one example of the present disclosure, providing a first workpiece, a second workpiece, and a weld rivet further includes that the first workpiece is a non-ferrous material and the second workpiece is a steel workpiece.

In another example of the present disclosure, providing a first workpiece, a second workpiece, and a weld rivet further includes that the first workpiece includes an aluminum alloy and the second workpiece is a steel workpiece.

In yet another example of the present disclosure, providing a first workpiece, a second workpiece, and a weld rivet further includes that the first workpiece includes a composite material and the second workpiece is a steel workpiece.

In yet another example of the present disclosure, providing a first workpiece, a second workpiece, and a weld rivet further includes that the first workpiece includes an aluminum alloy and the second workpiece is a steel tube.

In yet another example of the present disclosure, providing a first workpiece, a second workpiece, and a weld rivet further includes providing a third workpiece and that the first workpiece includes an aluminum alloy and the second workpiece and third workpiece are a steel alloy.

In yet another example of the present disclosure, providing a first workpiece, a second workpiece, and a weld rivet further includes that the weld rivet has a steel material and an electrically insulative coating.

In yet another example of the present disclosure, providing a first workpiece, a second workpiece, and a weld rivet further includes the weld rivet has a cap and a shank and the cap has an electrically insulative coating on a bottom surface of the cap.

In yet another example of the present disclosure, providing a first workpiece, a second workpiece, and a weld rivet further includes that the weld rivet has a cap and a shank portion. The cap portion has a first electrically insulative coating on a bottom surface. The shank portion has second electrically insulative coating on an outer surface.

In yet another example of the present disclosure, inserting the weld rivet through a hole of the first workpiece further includes piercing the first workpiece with the weld rivet forming a hole in the first workpiece and inserting the weld rivet through the hole of the first workpiece.

The above features and advantages and other features and advantages of the present disclosure are readily apparent from the following detailed description when taken in connection with the accompanying drawings.

### BRIEF DESCRIPTION OF THE DRAWING

The drawings described herein are for illustration purposes only and are not intended to limit the scope of the present disclosure in any way.

FIG. 1 is a cross section of a weld rivet according to the principles of the present disclosure;

FIG. 2A is a cross section depicting a step of a method of resistance element welding of dissimilar materials according to the principles of the present disclosure;

FIG. 2B is a cross section depicting a step of a method of resistance element welding of dissimilar materials according to the principles of the present disclosure;

FIG. 2C is a cross section depicting a step of a method of resistance element welding of dissimilar materials according to the principles of the present disclosure;

FIG. 2D is a cross section depicting a step of a method of resistance element welding of dissimilar materials according to the principles of the present disclosure;

FIG. 2E is a cross section depicting a step of a method of resistance element welding of dissimilar materials according to the principles of the present disclosure;

FIG. 3 is a cross section of a weld rivet and workpiece according to the principles of the present disclosure;

FIG. 4 is a cross section of a weld rivet and workpiece according to the principles of the present disclosure; and

FIG. 5 is a flowchart representing a method of joining workpieces of dissimilar materials according to the principles of the present disclosure.

### DESCRIPTION

The following description is merely exemplary in nature and is not intended to limit the present disclosure, application, or uses. The term “about” as used in the description is defined as an amount around a specific number that does not have a significant impact on the results of the operation or the design of an element.

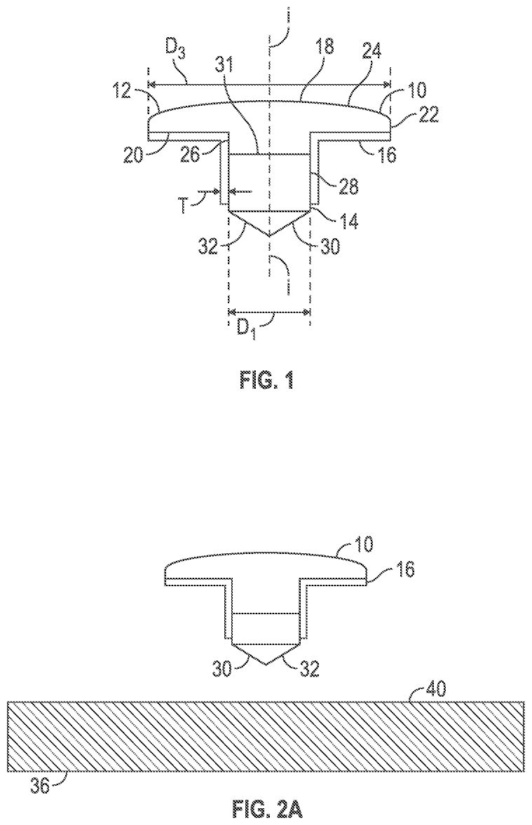

With reference to FIG. 1, a weld rivet 10 for use in a method of resistance element welding of dissimilar materials is illustrated and will now be described. The weld rivet 10 includes a head or cap portion 12, a shank portion 14, and a coating 16. More particularly, the cap portion 12 has a disc-like shape and includes a first surface 18, a second surface 20, and an outer perimeter surface 22. The first surface 18 is a curved surface 24 while the second surface 20 is flat when compared to the first surface 18. The first surface 18 is on the opposite side of the cap portion 12 from the second surface 20.

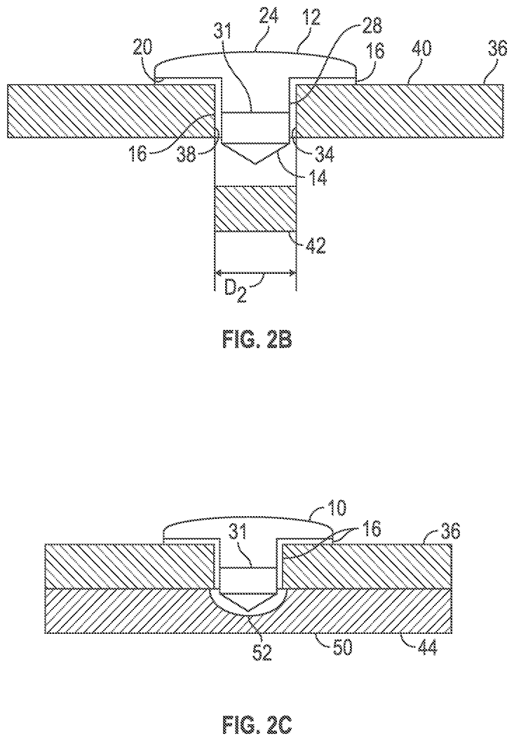

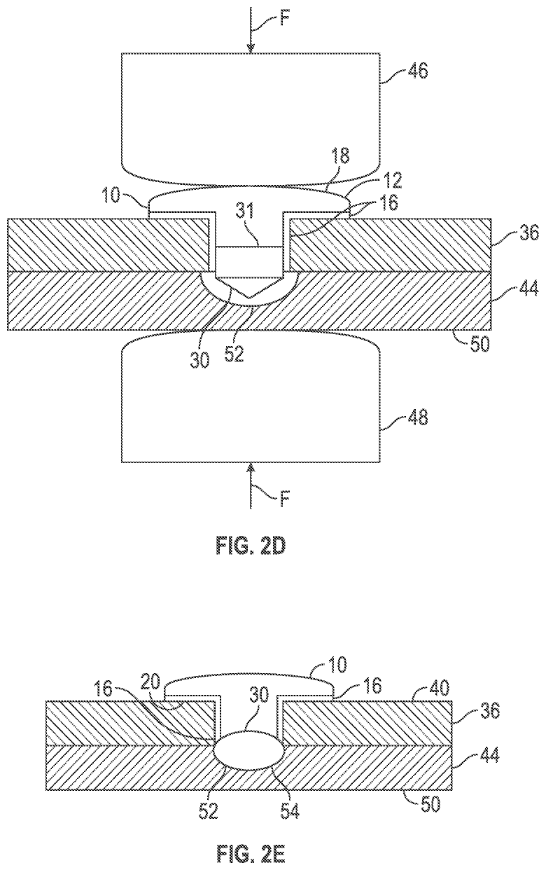

The shank portion 14 is predominantly cylindrical having a first end 26, an outer periphery surface 28, a second end 30 opposite the first end 26, and a retention feature 31. The first end 26 of the shank portion 14 is disposed on or adjacent to the second surface 20 of the cap portion 12 such that the axial center i of the shank portion 14 is axially aligned with the center of the cap portion j. The second end 30 of the shank portion 14 includes a forming tip 32. The forming tip 32 is a tip that is particularly designed to punch, cut, pierce, drill, or otherwise from a hole 34 in a first workpiece 36, shown more particularly in FIG. 2B. The specific design of the forming tip 32 depends upon the material of the first workpiece 36. For example, when the first workpiece 36 is an aluminum alloy, the forming tip 32 may be a punch or a piercing tip. Alternatively, when the first workpiece 36 is a composite material, the forming tip 32 may include a cutting edge that removes material upon rotating the weld rivet 10. The diameter D₁ of the hole 34 is the same or slightly larger than the diameter D₂ of the shank portion. Preferably, the diameter D₂ of the shank portion 14 is in the rage of about 4 to 8 mm while a diameter D₃ of the cap portion is in the range of about 8 to 16 mm. However, these dimensions of the weld rivet 10 may vary according to requirements of the joint formed using the weld rivet 10 as will be described further below. The retention feature 31 of the shank portion 14 provides an interference fit between the shank portion 14 and the first workpiece 36 as will be described further below. The retention feature 31 may be a groove or a small increased diameter portion that retains the weld rivet 10 in the first workpiece 36 when the weld rivet 10 is installed in the first workpiece 36.

The coating 16 of the weld rivet 10 is first disposed on the portion of the second surface 20 that is exposed or not covered by or attached to the first end 26 of the shank portion 14. A second disposition of the coating 16 covers the outer periphery surface 28 of the shank portion 14. The coating 16 is an electrically insulating or insulative material having a thickness T between 0.05 and 0.25 mm. The coating 16 may be one of a silicon resin, a ceramic, or an epoxy powder. A particular coating 16 may be selected from one of Bluesil RES 6405 and Tyranno Coat® while other coatings 16 may also be used. The coating 16 is capable of reducing electrical current shunting to adjacent materials as will be described below.

Turning now to FIGS. 2A-2E, several steps of a method of joining two workpieces having dissimilar materials are illustrated and will now be described. Initially, a location for an attachment point or a joint is specified in FIG. 2A. FIG. 2B illustrates the weld rivet 10 punched into the first workpiece 36 as previously described thus forming the hole 34 in the first workpiece 36 having an inner peripheral surface 38 and discarding the blank 42. After the forming of the hole 34, the weld rivet 10 remains in the hole 34 such that the coating 16 of the outer periphery surface 28 of the shank portion 14 is in contact with the inner peripheral surface 38 of the first workpiece 36. The weld rivet 10 is retained in the first workpiece 36 by way of the retention feature 31. Also, the coating 16 of the second surface of the cap portion 12 is in contact with a first surface 40 of the first workpiece 36. As shown in FIG. 2C, the first workpiece 36 with the weld rivet 10 is stacked or located on a second workpiece 44. As welding operation, the material of the weld rivet 10 is the similar material of the second workpiece 44. In most applications, the first workpiece 36 will have a melting point that is less than the melting point of the second workpiece 44. FIG. 2D illustrates the welding electrodes in position with a first welding electrode 46 disposed in contact with the first surface 18 of the cap portion 12 and a second welding electrode 48 disposed in contact with a first surface 50 of the second workpiece 44. A prescribed amount of force F is applied to the weld rivet 10 and the second workpiece 44 via the electrodes 46, 48. Electric current is applied to the assembly through the electrodes 46, 48 resulting in the melting of the second end 30 of the weld rivet 10 and a portion 52 of the second workpiece 44 in contact with the second end 30 of the weld rivet 10. The coating 16 reduces current shunting into the first workpiece 36. As the electric current is discontinued the second end 30 and the portion 52 of the second workpiece 44 solidifies to form a newly joined weld pool 54 containing material of both the second end 30 of the weld rivet 10 and the portion 52 of the second workpiece 44. Since the coating 16 intercedes between the second surface 20 of the cap portion 12 from the first surface 40 of the first workpiece 36 and the outer periphery surface 28 of the shank portion 14 from the inner peripheral surface 38 of the first workpiece 36, the first surface 40 and inner peripheral surface 38 do not soften from the Joule heat of the electric shunting current and remains resilient to the force F applied by the electrodes 46, 48. As a result, the cap portion 12 of the weld rivet 10 remains in place and does not sink into the first workpiece 36.

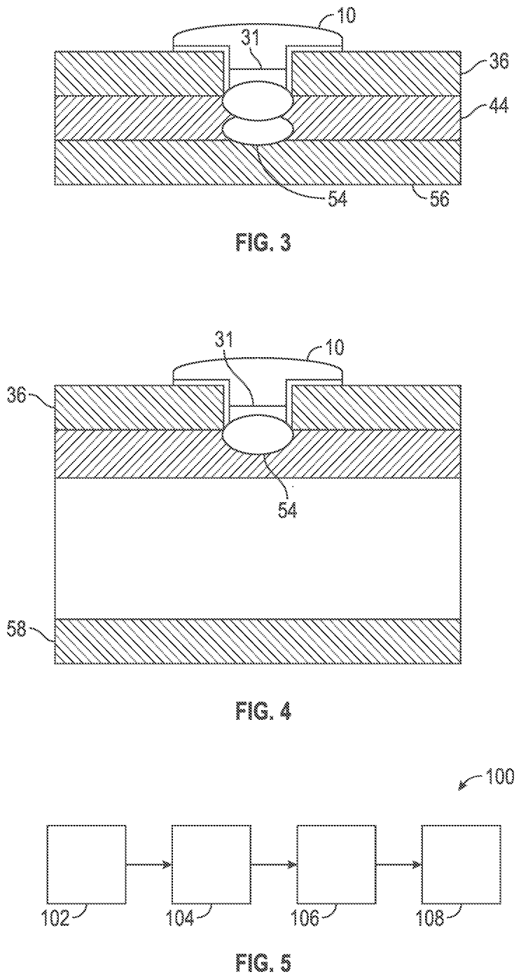

Referring now to FIGS. 3 and 4, alternative assemblies are shown that incorporate the weld rivet 10 and the method of joining two or more workpieces having dissimilar materials. In the example shown in FIG. 3, a third workpiece 56 is included using a similar method as previously described. Additionally, FIG. 4 provides an example of an assembly having an alternative second workpiece 58 such as a tube or pipe. In all examples of the present disclosure, the second workpiece 44, 58 and the weld rivet 10 may include a steel alloy. Alternatively, the first workpiece 36 may be any type of metal alloy or carbon fiber polymeric composite material without departing from the scope of the disclosure. In most applications, the first workpiece 36 will have a melting point that is less than the melting point of the second workpiece 44.

Now turning to FIG. 5, with continuing reference to FIGS. 1-4, a flowchart depicts a method 100 of joining at least two workpieces of dissimilar materials. A first step 102 includes providing a weld rivet 10 as previously described. A second step 104 includes using the weld rivet 10 for punching, piercing, or otherwise forming a hole 34 in the first workpiece 36 and inserting the weld rivet 10 into the hole 34 of the first workpiece 36. In an alternative example, the coating 16 may be applied directly to a top surface of the first workpiece 36 in leu of having a weld rivet 10 provided with a coating 16. A third step 106 provides a pair of electrodes and a second workpiece 44; with a first welding electrode 46 contacting and applying a force F to the first surface 18 of the cap portion 12 of the weld rivet and a second welding electrode 48 contacting and applying a force F to a lower or first surface 50 of the second workpiece. A fourth step 108 applies an electric current to the electrodes creating a pool 54 of melted material between the second end 30 of the shank portion 14 of the weld rivet 10 and a portion 52 of the second workpiece in adjacent to the second end 30 of the shank portion 14 of the weld rivet 10.

While examples have been described in detail, those familiar with the art to which this disclosure relates will recognize various alternative designs and examples for practicing the disclosed structure within the scope of the appended claims.

The following is claimed:

1. A weld rivet for use in resistance element welding of dissimilar materials, the weld rivet comprising:
a shank portion having a cylindrical shape, a first end, and a second end opposite the first end;
a cap portion having a first surface, and a second surface, and wherein the second surface of the cap portion is disposed on the first end of the shank portion; and
a coating disposed on the second surface of the cap portion, and wherein the coating is an electrically insulative coating.

2. The weld rivet of claim 1 wherein the coating is further disposed on an outer surface of the shank portion.

3. The weld rivet of the claim 1 wherein the first surface of the cap portion has a round shape.

4. The weld rivet of claim 1 wherein the cap portion has a diameter of about 8 to 16 mm and the shank portion has a diameter of about 4 to 8 mm.

5. The weld rivet of claim 1 wherein the second end of the shank portion has a piercing tip capable of piercing through an aluminum workpiece.

6. The weld rivet of claim 1 wherein the second end of the shank portion has a self-drilling tip capable of forming a hole through a nonmetallic sheet.

7. A weld rivet for use in resistance element welding of dissimilar materials, the weld rivet comprising:
a shank portion having a cylindrical shape, a first end, a second end opposite the first end, and an outer surface, and wherein the second end of the shank portion has a forming tip capable of forming a hole through a workpiece;
a cap portion having a flat disc shape, a rounded top surface, and a bottom surface, and wherein the bottom surface of the cap portion is disposed on the first end of the shank portion; and
a coating disposed on the bottom surface of the cap portion and the outer surface of the shank portion, and wherein the coating electrically insulates the cap portion and the shank portion.

8. The weld rivet of claim 7 wherein the cap portion has a diameter of about 8 to 16 mm and the shank portion has a diameter of about 4 to 8 mm.

9. The weld rivet of claim 7 wherein the second end of the shank portion has a piercing tip capable of piercing through an aluminum workpiece.

10. The weld rivet of claim 7 wherein the second end of the shank portion has a self-drilling tip capable of forming a hole through a nonmetallic sheet.

11. A method of joining dissimilar materials, the method comprising:
providing a first workpiece, a second workpiece, and a weld rivet;
inserting the weld rivet through a hole of the first workpiece;
disposing the second workpiece adjacent to the first workpiece such that the weld rivet is in contact with the second workpiece; and
applying a high current electrical charge between the weld rivet and the second workpiece.

12. The method of claim 11 wherein providing a first workpiece, a second workpiece, and a weld rivet further comprises providing the first workpiece, the second workpiece, and the weld rivet, and wherein the first workpiece is a non-ferrous material and the second workpiece is a steel workpiece.

13. The method of claim 11 wherein providing a first workpiece, a second workpiece, and a weld rivet further comprises providing the first workpiece, the second workpiece, and the weld rivet, and wherein the first workpiece includes an aluminum alloy and the second workpiece is a steel workpiece.

14. The method of claim 11 wherein providing a first workpiece, a second workpiece, and a weld rivet further comprises providing the first workpiece, the second workpiece, and the weld rivet, and wherein the first workpiece includes a polymeric composite material and the second workpiece is a steel workpiece.

15. The method of claim 11 wherein providing a first workpiece, a second workpiece, and a weld rivet further comprises providing the first workpiece, the second workpiece, and the weld rivet, and wherein the first workpiece includes an aluminum alloy and the second workpiece is a steel tube.

16. The method of claim 11 wherein providing a first workpiece, a second workpiece, and a weld rivet further comprises providing the first workpiece, the second workpiece, the third workpiece, and the weld rivet, and wherein the first workpiece includes an aluminum alloy and the second workpiece and third workpiece are a steel alloy.

17. The method of claim 11 wherein providing a first workpiece, a second workpiece, and a weld rivet further comprises providing the first workpiece, the second workpiece, and the weld rivet, and wherein the weld rivet includes a steel material and has an electrically insulative coating.

18. The method of claim 11 wherein providing a first workpiece, a second workpiece, and a weld rivet further comprises providing the first workpiece, the second workpiece, and the weld rivet, and wherein the weld rivet has a cap portion and a shank portion, and the cap portion has an electrically insulative coating on a bottom surface of the cap portion.

19. The method of claim 11 wherein providing a first workpiece, a second workpiece, and a weld rivet further comprises providing the first workpiece, the second workpiece, and the weld rivet, and wherein the weld rivet has a cap portion and a shank portion, the cap portion has a first electrically insulative coating on a bottom surface, and the shank portion has second electrically insulative coating on an outer surface of the shank portion.

20. The method of claim 19 wherein inserting the weld rivet through a hole of the first workpiece further comprises piercing the first workpiece with the weld rivet forming a hole in the first workpiece and inserting the weld rivet through the hole of the first workpiece.
